(19) United States
(12) Patent Application Publication
(10) Pub. No.: US 2013/0162801 A1
(43) Pub. Date: Jun. 27, 2013

(54) MICROSCOPE

(71) Applicant: Canon Kabushiki Kaisha, Tokyo (JP)

(72) Inventors: Kazuhiko Kajiyama, Utsunomiya-shi (JP); Tomoaki Kawakami, Utsunomiya-shi (JP); Toshihiko Tsuji, Utsunomiya-shi (JP); Masayuki Suzuki, Utsunomiya-shi (JP)

(73) Assignee: CANON KABUSHIKI KAISHA, Tokyo (JP)

(21) Appl. No.: 13/719,023

(22) Filed: Dec. 18, 2012

(30) Foreign Application Priority Data
Dec. 21, 2011 (JP) 2011-279723

(51) Int. Cl. H04N 7/18

(52) U.S. Cl. CPC H04N 7/18
USPC 348/79

(57) ABSTRACT

Provided is a microscope which includes an image pickup element, a light source, an optical system, a control unit and a sensor. The control unit controls for the acquisition of, in parallel with the first image pickup event by the image pickup element, necessary information when the second image pickup event by the image pickup element is performed, by using the sensor. A pair of sensors for a microscope includes a pair of sensors. A first sensor of the pair of sensors provides a signal that represents an environmental variable of a first area at a first period in time. A second sensor of the pair of sensors provides a signal that represents a quality of the first sensor's ability to represent the environmental variable of a second area at the first period in time, wherein the second sensor is adjacent to the first sensor.

### BACKGROUND OF THE INVENTION

1. Field of the Invention

The present invention relates to a microscope under which, for example, a specimen is examined.

2. Description of the Related Art

In current pathological examination, a pathological specimen is directly observed by human eyes using an optical microscope. Recently, microscopes which take pathological specimens in as image data for observation on a display have been developed. With such a microscope, since image data of a pathological specimen is observed on a display, a plurality of observers may see the image data at the same time. This kind of microscope enables diagnosis by a remote pathologist with whom image data is shared. However, the related art microscopes take a long time to obtain an image of a pathological specimen and present it as image data.

One of the causes of taking a long time to obtain an image is that a pathological specimen with a large image pickup area needs to be taken in as image data using an objective lens with narrow image pickup range. If the image pickup range of the objective lens is narrow, it is necessary to perform a plurality of image pickup events, or pick images up while scanning and then connect the pieces of scanned data to acquire single image data. An objective lens with a large image pickup range is required in order to reduce the number of image pickup events and shorten time for taking image data in.

Japanese Patent Laid-Open No. 2009-063655 discloses acquiring single image data by connecting a plurality of pieces of image data obtained by a plurality of image pickup events, using an objective lens with a large image pickup range and an image pickup unit in which a plurality of image pickup elements are arranged.

With such microscope using an objective lens having a large image pickup range as that of the Japanese Patent Laid-Open No. 2009-063655, it may be expected that image pickup time (i.e., from the start to the end of electrification storage) is shortened and image data of a larger area, such as the entire image, may be acquired in a shorter time as compared with microscopes with narrow image pickup range.

However, picking an image and obtaining image data need information, such as a focusing position and an exposure amount. Therefore, methods for acquisition of such information are also important for the acquisition of image data in a short time. For example, if such information is acquired for each image pickup event among a plurality of image pickup events, acquisition of information takes long time: therefore, image data is not necessarily acquired in a short time in this manner.

### SUMMARY OF THE INVENTION

A microscope, including: an image pickup element; a light source configured to illuminate an object; an optical system configured to project an image of the object on the image pickup element; a control unit configured to, when an image of the object is to be picked up with the image pickup element, perform a plurality of image pickup events and acquire a plurality of pieces of image data by the plurality of image pickup events, the plurality of image pickup events including a first image pickup event in which a first area of the object is picked up, and a second image pickup event in which a second area which is different from the first area is picked up while a relative position of the image pickup element and the object being changed; and a sensor configured to acquire necessary information when picking the image of the object up by the image pickup element, wherein the control unit controls for the acquisition of, in parallel with the first image pickup event by the image pickup element, necessary information when the second image pickup event by the image pickup element is performed, by using the sensor. A pair of sensors for a microscope image pickup device including a pair of sensors. A first sensor of the pair of sensors provides a signal that represents an environmental variable of a first area at a first period in time. A second sensor of the pair of sensors provides a signal that represents a quality of the first sensor's ability to represent the environmental variable of a second area at the first period in time, wherein the second sensor is adjacent to the first sensor.

Further features according to the present invention will become apparent from the following description of exemplary embodiments with reference to the attached drawings.

### BRIEF DESCRIPTION OF THE DRAWINGS

FIG. 1 is a schematic cross-sectional view illustrating a configuration of a microscope.

FIGS. 2A and 2B illustrate arrangements of image pickup elements.

FIGS. 3A and 3B illustrate the image pickup elements and image pickup areas.

FIG. 4A is a schematic diagram of a sensor configured to acquire an imaging position.

FIG. 4B and FIG. 4C are graphs illustrating relationships between light intensity and an imaging position.

FIG. 5 is a diagram related to illumination for the acquisition of the imaging position.

FIG. 6 is a diagram illustrating an image pickup procedure according to a first embodiment.

FIG. 7 is a diagram illustrating an image pickup procedure according to a second embodiment.

### DESCRIPTION OF THE EMBODIMENTS

### First Embodiment

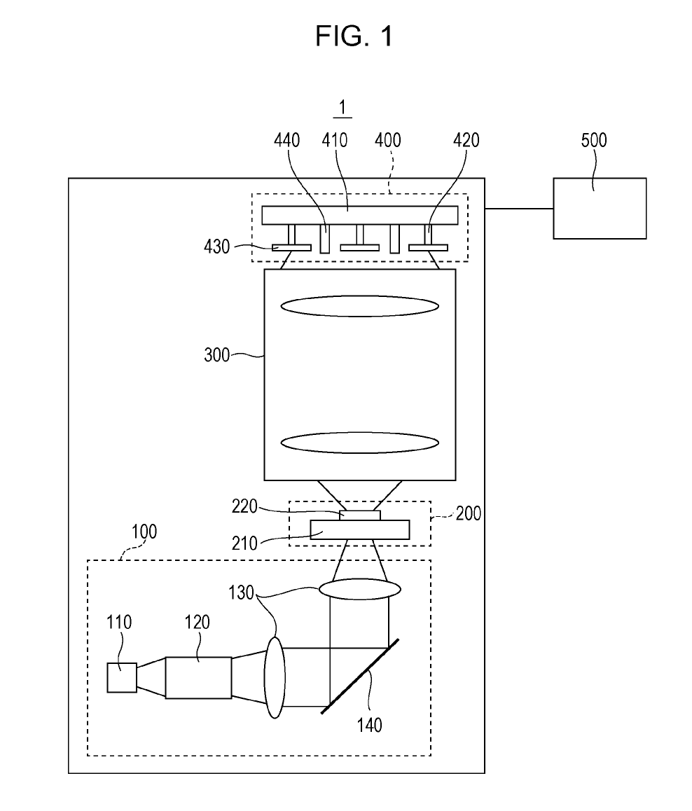

FIG. 1 is a schematic diagram of a microscope of the present embodiment.

A microscope 1 includes an illumination optical system 100, a specimen unit 200, an image pickup optical system 300, an image pickup unit 400 and a controller 500. The illumination optical system 100 illuminates the entire specimen at a uniform illumination level by equalizing light from a light source unit 110 via an optical integrator unit 120 and guiding the equalized light to a specimen 220 via a lens 130 or a mirror 140. The light source unit 110 is formed by, for example, one or more halogen lamps, xenon lamps and LEDs. The specimen unit 200 includes a specimen stage 210 and the specimen 220 which is an object of which image is to be picked up. The specimen stage 210 is configured to move the specimen 220 in several directions: e.g., in parallel with, vertical to or inclined with respect to an optical axis direction of the image pickup optical system 300. The image pickup optical system 300 projects an image of an illuminated specimen on image pickup elements 430. The image pickup unit 400 includes an image pickup stage 410, an image pickup element driving unit 420, the image pickup elements 430, such as CCDs and CMOSs, and a sensor 440 for acquiring image pickup information. A plurality of image pickup elements 430 are arranged in parallel with one another and a plurality of sensors for acquiring image pickup information 440 are disposed among the image pickup elements 430. The controller 500 controls for the image pickup by the image pickup elements 430, for the acquisition of necessary information for image pickup using the sensor 440 for acquiring image pickup information, and for the driving of the specimen stage 210 and the image pickup element driving unit 420. With such control, a plurality of image pickup events are performed which include a first image pickup event in which an area where a specimen 220 exists (first area) is picked up, and a second image pickup event in which another area (second area) is picked up after the first image pickup event while the relative positions of the image pickup elements 430 and the specimen 220 being changed. Then, single image data is acquired from the plurality of pieces of image data obtained in the plurality of image pickup events.

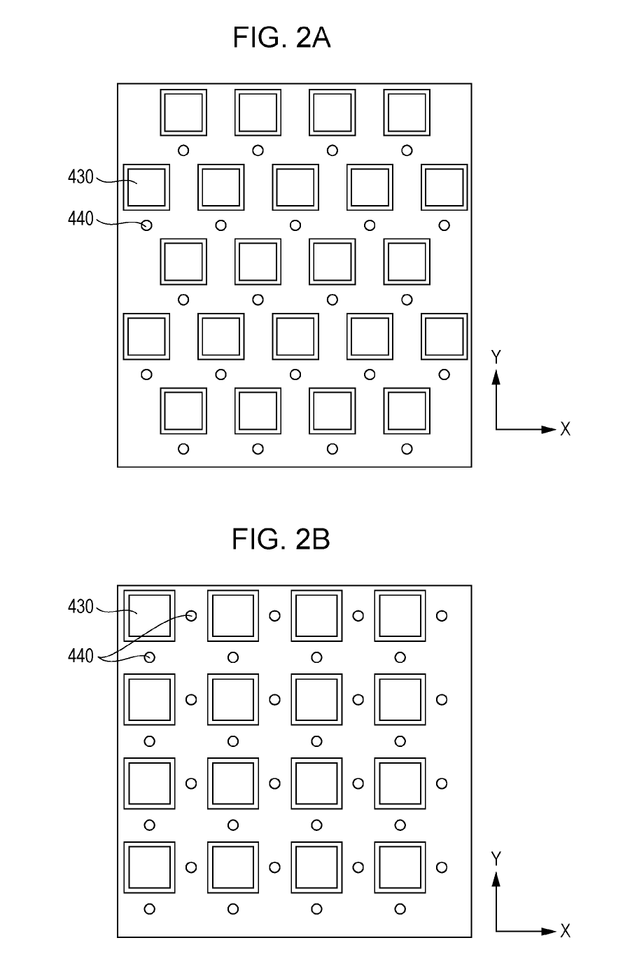

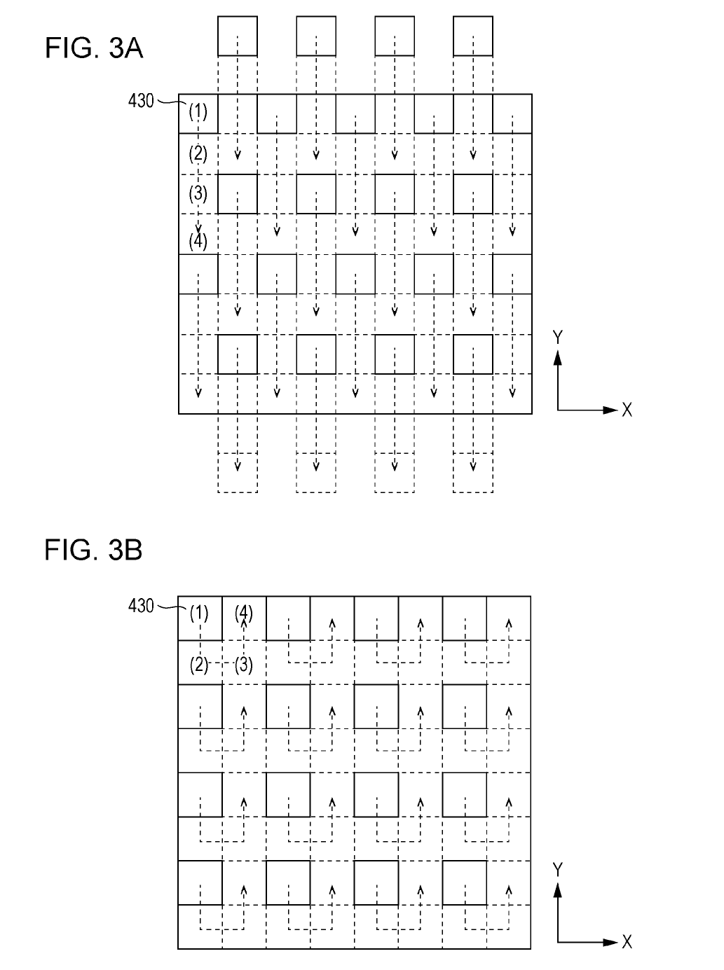

In the present embodiment, the sensor for acquiring information about the imaging position is used as the sensor 440 for acquiring image pickup information. FIGS. 2A and 2B illustrate arrangements of the image pickup elements 430 and the sensors 440 seen from the optical axis direction of the image pickup optical system 300. FIGS. 3A and 3B illustrate movements of relative positions of the image pickup elements 430 and the specimen 220 by arrows at the time of picking up of the image. In FIGS. 3A and 3B, (1) to (4) represent an exemplary order of picking by a single image pickup element 430. The arrangements of the image pickup elements 430 and the sensors 440 are changed depending on how the relative positions of the image pickup elements 430 and the specimen 220 are moved to acquire a plurality of pieces of image data.

In the arrangement of FIG. 2A, as illustrated in FIG. 3A, each image pickup element 430 picks four images as it moves three cells in the −Y direction ((2), (3) and (4) in the diagram) from (1) with respect to the specimen 220 and then connects the obtained plurality of pieces of image data into single image data. While the image pickup element 430 picks the image up, each sensor 440 is moved in the −Y direction of the image pickup element 430 so that the information about the imaging position of the area to be picked subsequently can be acquired. In this manner, image pickup of a certain area (e.g., the area (1)) by the image pickup element 430 and acquisition of information about the imaging position of an area to be picked subsequently (e.g., the area (2)) by the sensor 440 can be carried out in parallel. Therefore, time required for the entire image pickup can be shortened.

In the arrangement of FIG. 2B, as illustrated in FIG. 3B, each image pickup element 430 picks four images as it moves three cells in the −Y direction (2), +X direction (3) and +Y direction (4) from (1) with respect to the specimen 220 and then connects the obtained plurality of pieces of image data into single image data. Although the image pickup element 430 is moved here for the ease of description, the specimen 220 may be moved with respect to the image pickup element 430 by the specimen stage 210. By arranging the sensors 440 to the −Y direction and to the +X direction of the image pickup elements 430, the information about the imaging position of the area to be picked can be acquired. Therefore, image pickup and acquisition of the information about the imaging position can be carried out in parallel. Carrying out image pickup and acquisition of information about the imaging position in parallel requires time in which the sensors 440 acquire information about the imaging position in parallel at least the time from the start to the end of electrification storage in the image pickup elements 430. Desirably, acquisition of the information about the imaging position by the sensors 440 is completed during the time from the start to the end of the electrification storage in the image pickup element 430 and calculation of the imaging position is completed until the position of the specimen 220 and the image pickup elements 430 in the plane direction is determined. In this manner, the time after the position of the specimen 220 and the image pickup elements 430 in the plane direction is determined and before the image pickup is started can be further shortened.

In the arrangement of the image pickup elements illustrated in FIG. 2B, the information about the imaging position of an area (2) is acquired using the sensors 440 of the −Y direction and information about the imaging position of an area (4) is acquired using the sensors 440 of the +X direction in parallel with the image pickup of an area (1). Next, in parallel with the image pickup of the area (2) by the image pickup element 430, information about the imaging position of the area (3) is acquired using the sensor 440 of the +X direction. In parallel with the image pickup of the area (1), the image pickup of the area (4) is carried out using the information about the imaging position of the area (4) acquired in parallel with the image pickup of the area (1). Therefore, it is possible to shorten the time required for the entire image pickup. The optimum arrangement of the sensors 440 in order to carry out the image pickup and the acquisition of the information about the imaging position in parallel is the arrangement of a plurality of sensors 440 at the same intervals as those of the image pickup elements 430. In the arrangement of FIG. 2A, since the relative positions of the image pickup elements 430 and the specimen 220 are changed only in the Y direction, the sensors 440 are arranged at positions displaced by one from the image pickup elements 430 in the Y direction at the same intervals as those of the image pickup elements 430. In this case, as many sensors 440 as the image pickup elements 430 are needed. In the arrangement of FIG. 2B, since the relative positions of the image pickup elements 430 and the specimen 220 are changed in two directions: X direction and Y direction, the sensors 440 are arranged at positions displaced by one from the image pickup elements 430 in the X direction and in the Y direction at the same intervals as those of the image pickup elements 430. In this case, twice as many sensors 440 as the image pickup elements 430 are needed.

In any arrangement, the information about the imaging position of the area first to be picked is not able to be acquired in parallel with image pickup. However, the influence caused by this fact becomes small as the number of image pickup events increases and, therefore, speed-up can be expected.

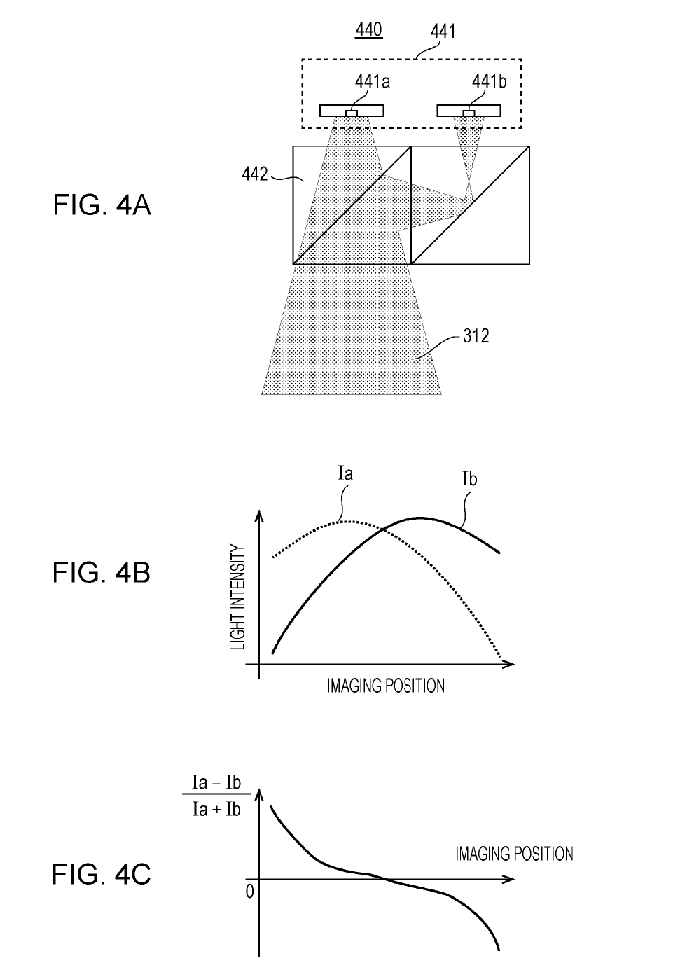

Next, an exemplary configuration of the sensor 440 for acquiring the information about the imaging position and an exemplary acquisition method of the information about the imaging position will be described with reference to FIGS. 4A and 4B. As illustrated in FIG. 4A, the sensor 440 includes a half prism 442 which divides light 312 from the image pickup optical system 300, and a light intensity sensor 441 which acquires light intensity of the divided light. The light divided by the half prism 442 is received by two light-receiving surfaces 441a and 441b of the light intensity sensor 441 and light intensity is acquired. The size of the two light-receiving surfaces 441a and 441b of the light intensity sensor 441 is as small as the minimum spot size made by the image pickup optical system 300. Thus, the same effect as a pinhole effect is produced. Since the two light-receiving surfaces 441a and 441b are adjusted to be at equal distance from the imaging surface of the image pickup optical system 300, the imaging surface of the image pickup optical system 300 and the imaging position of the specimen 220 coincide with each other when the two light-receiving surfaces 441a and 441b detect the same light intensity.

FIG. 4B illustrates the light intensity received by the two light-receiving surfaces 441a and 441b by a solid line (light intensity received by the light-receiving surface 441b) and a dotted line (light intensity received by the light-receiving surface 441a) with the light intensity represented by the vertical axis and the imaging position represented by the horizontal axis. In FIG. 4C, (Ia−Ib)/(Ia+Ib) is represented by the vertical axis and the imaging position is represented by the horizontal axis. As illustrated in FIG. 4B, curves representing the intensity of light received by the two light-receiving surfaces 441a and 441b of the light intensity sensor 441 are the same, peaked shape. At this time, as illustrated in FIG. 4C, (Ia−Ib)/(Ia+Ib) becomes 0 at a certain imaging position, where the image pickup elements 430 and the imaging positions coincide with each other. The imaging position can be quantitatively measured on the basis of the light intensity received by the two light intensity sensors 441. If (Ia−Ib)/(Ia+Ib) is positive, the imaging position is front and if (Ia−Ib)/(Ia+Ib) is negative, the imaging position is rear. Thus the signal of (Ia−Ib)/(Ia+Ib) of sensor 440 is indicative of the quality of the optical signal relative to the imaging position along the optical axis that the imaging sensor 430 would have if the imaging sensor 430 was located at the current position of the sensor 440 in the imaging plane.

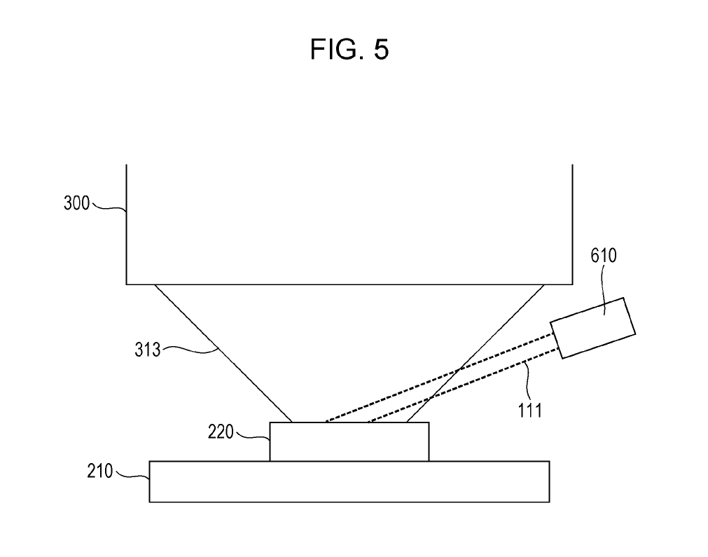

Next, illumination for the acquisition of the information about the imaging position will be described with reference to FIG. 5. Supplementary light 111 for the acquisition of the information about the imaging position is supplied from a light source 610 which is separately provided from the light source unit 110 for the image pickup. The supplementary light 111 illuminates the specimen 220 from an oblique direction so that it is dark field illumination from the outside of the light beam for the image pickup 313. At the time of acquisition of the information about the imaging position, noise and error can be reduced by using dark field illumination and acquiring only scattered light from the specimen 220, whereby reliability of the measurement can be increased. Keeping light of the light source unit 110 for the image pickup out of the sensor 440 also reduces noise and error. It is therefore desirable that illumination areas of lights of different purposes do not overlap with each other on the specimen 220 and that the specimen 220 is illuminated locally. In order to achieve such a configuration, it is possible to provide a light-shielding unit at a position conjugate with the specimen 220 so that the illumination optical system 100 does not illuminate other than the image pickup element 430. By providing a plurality of light sources, it is possible to locally illuminate each image pickup element 430 by each of the light sources.

As described above, information about the imaging position necessary for image pickup is acquired by a series of operations from the start of the supply of supplementary light by the light source 610 to the calculation of the imaging position, the driving amount and the driving direction of the image pickup element driving unit 420 is determined by the controller 500, and the image pickup element 430 is driven. Thereafter, the image is picked up.

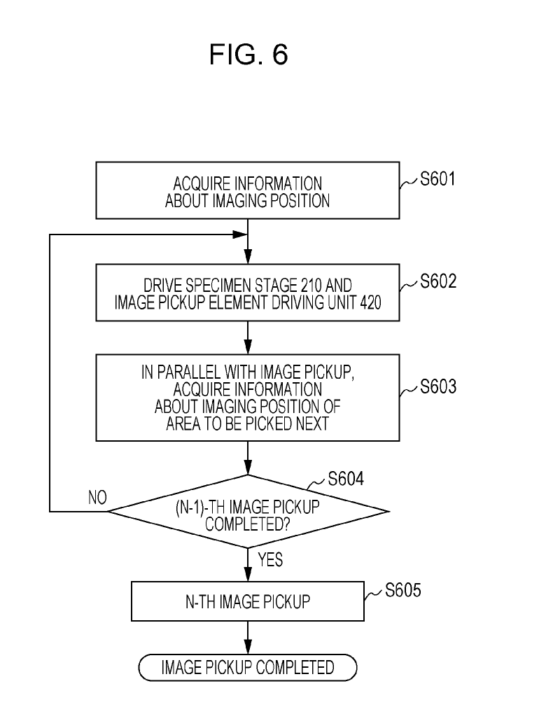

An image pickup procedure of the present embodiment will be briefly illustrated with reference to FIG. 6.

First, the specimen 220 is moved by the specimen stage 210, and the information about the imaging position of the area of the specimen 220 to be picked first at the initial position using the sensor 440 is acquired (S601). Then, the specimen stage 210 and the image pickup element 430 are driven such that the image pickup element 430 corresponds to the imaging position on the basis of the information about the imaging position acquired in 5601 (S602). At that position, the information about the imaging position of the area to be picked next using the sensor 440 in parallel with the image pickup by the image pickup element 430 is acquired (S603). If all the image pickup areas are picked by N image pickup events, it is determined whether (N−1)-th image pickup has been terminated (S604). If the (N−1)-th image pickup has been terminated, the specimen stage 210 and the image pickup element driving unit 420 are driven such that the image pickup element 430 corresponds to the imaging position, and the N-th image pickup is carried out (S605). At this time, the information about the imaging position using the sensor 440 is not acquired. If (N−1)-th image pickup is not terminated, the process returns to 5602.

When the images of all the image pickup areas are picked up in this manner, a process to connect the obtained plurality of pieces of image data into single image data is carried out.

### Second Embodiment

In the present embodiment, a sensor for acquiring information about an exposure amount is used as a sensor 440 for acquiring image pickup information. The same components as those of the first embodiment described with reference to FIGS. 1 to 6 are not described again.

The arrangement of the sensors 440 for acquiring information about the exposure amount changes depending on the arrangement of the image pickup elements 430 and depending on how the image is to be acquired with the relative positions of the image pickup elements 430 and the specimen 220 are moved: however, the sensors 440 are arranged in the same manner as in the first embodiment.

In this embodiment, which is different from the first embodiment, the CMOS or the CCD having a certain amount of area, such as the image pickup element 430, is used as the sensor 440 for acquiring the information about the exposure amount. Therefore, light intensity of a large area can be acquired and reliability can be improved. The light intensity sensor is not limited to the CMOS and CCD: but any sensors may be used as long as they are capable of detecting light intensity from the image pickup area. The minimum, not excessively dark for the specimen 220, exposure amount may be determined by determining the exposure amount on the basis of the lowest exposure amount among the exposure amounts obtained by a plurality of sensors. Illuminating the specimen 220 with the minimum exposure amount, white out of the image can be reduced. The light source unit 110 for the image pickup may be used to acquire the information about the exposure amount.

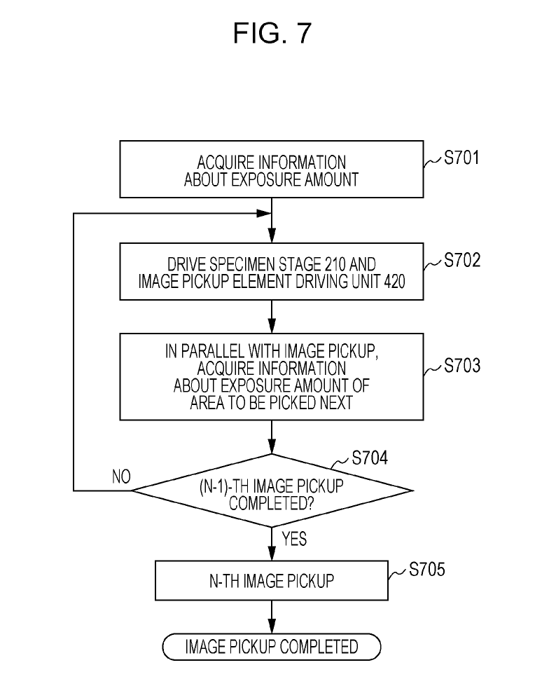

An image pickup procedure of the present embodiment will be briefly illustrated with reference to FIG. 7.

First, the information about the exposure amount is acquired at the initial position using the sensor 440 (S701). Next, the specimen stage 210 is controlled and the specimen 220 is moved to the position at which image pickup is performed (S702). The exposure amount is controlled using the information about the exposure amount acquired in 5701 and, in parallel with the image pickup by the image pickup element 430, the information about the exposure amount of the area to be picked next is acquired using the sensor 440 (S703). If all the image pickup areas are picked by N image pickup events, it is determined whether (N−1)-th image pickup has been terminated (S704). If the (N−1)-th image pickup has been terminated, the exposure amount is controlled using the acquired exposure amount and the N-th image pickup is carried out (S705). At this time, the information about the exposure amount using the sensor 440 is not acquired. If (N−1)-th image pickup is not terminated, the process returns to 5702.

When the images of all the image pickup areas are picked up, a process to connect the obtained plurality of pieces of image data into single image data is carried out.

As described above, the specimen 220 may be picked with suitable exposure amount by acquiring the information about the exposure amount necessary for the image pickup by a series of operations from the start of acquiring light intensity until the calculation of the exposure amount of the sensor 440, and by properly controlling output and emission time of the light source unit 110 by the controller 500. The exposure amount may be controlled also by inserting and removing, for example, a filter in an optical path, or controlling charge storage time of the image pickup element.

Although the information about the imaging position and the information about the exposure amount have been described as information acquired in parallel with the image pickup, the present invention is not limited to the same. For example, the first embodiment and the second embodiment may be combined.

There is a possibility that a wave front is changed for each image pickup area under the influence of, for example, a cover glass covering the specimen 220, a sensor 440 for acquiring image pickup information with a function to measure the wave front may be used.

Although there is an effect of shortening the image data acquisition time even if there is a time lag between an image pickup event and an information acquisition event, the time-shortening effect is the largest when the time lag is the smallest. Therefore, what kind of sensor 440 for acquiring image pickup information is to be provided is to be considered for each microscope system. Although the arrangements of the image pickup elements 430 and the sensors 440 have been described with reference to FIG. 2, the illustrated arrangements are not restrictive. For the ease of the description of the image pickup procedure, the sensor 440 acquires the information about the area to be picked next: however, it is only necessary that information about the area to be subsequently picked is acquired in a series of processes of picking all the image pickup area.

An embodiment of the present invention is to perform image pickup of the first area and acquisition of necessary information for the image pickup of the area to be picked up (i.e., the second area different from the first area) in parallel when single image data is to be obtained from pieces of image data obtained by a plurality of image pickup events. Therefore, all the configurations having this concept are included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-279723 filed Dec. 21, 2011, which is hereby incorporated by reference herein in its entirety. cm What is claimed is:

1. A microscope, comprising:
an image pickup element;
a light source configured to illuminate an object;
an optical system configured to project an image of the object on the image pickup element;
a control unit configured to, when an image of the object is to be picked up with the image pickup element, perform a plurality of image pickup events and acquire a plurality of pieces of image data by the plurality of image pickup events, the plurality of image pickup events including a first image pickup event in which a first area of the object is picked up, and a second image pickup event in which a second area which is different from the first area is picked up while a relative position of the image pickup element and the object being changed; and
a sensor configured to acquire necessary information when picking the image of the object up by the image pickup element,
wherein the control unit controls for the acquisition of, in parallel with the first image pickup event by the image pickup element, necessary information when the second image pickup event by the image pickup element is performed, by using the sensor.

2. The microscope according to claim 1, wherein the sensor is configured to acquire information about an imaging position.

3. The microscope according to claim 2, further comprising a driving unit configured to drive the image pickup element, wherein the control unit controls the driving unit in accordance with the acquired information about the imaging position.

4. The microscope according to claim 1, wherein the sensor is configured to acquire information about an exposure amount.

5. The microscope according to claim 1, wherein:
a plurality of image pickup elements are arranged; and
the sensors are disposed among the plurality of image pickup elements.

6. A pair of sensors for a microscope comprising:
a first sensor of the pair of sensors provides a signal that represents an optical variable of a first area at a first period in time; and
a second sensor of the pair of sensors provides a signal that represents a quality of the first sensor's ability to represent the optical variable of a second area at the first period in time, wherein the second sensor is adjacent to the first sensor.

7. The pair of sensors for the microscope of claim 6, further comprising:
a translation stage arranged so as to position the first sensor to provide a signal that represents the environmental variable of the second area at a second period in time, wherein the apparatus is adjusted based upon the signal from the second sensor.

8. The pair of sensors for the microscope of claim 6, wherein a plurality of the pair of sensors are arranged in a gird, such that:
a gird of the first sensors provide a plurality of signals that represent environmental variables of a gird of first areas at the first period in time; and
a grid of the second sensors provide a plurality of signals that represent qualities of the gird of first sensors' ability to represent the environmental variables of a grid of second areas at the first period in time, wherein the grid of second areas is interleaved with the grid of the first areas.

9. The pair of sensors for the microscope of claim 8, further comprising:
a translation stage arranged so as to position the grid of first sensors to provide signals that represent the environmental variable of the grid of second areas at a second period in time, wherein the apparatus is adjusted based upon the plurality of signals from the second sensor.

10. The pair of sensors for the microscope of claim 9, further comprising:
a sample stage; and
a source; wherein:
the translation stage moves either the sample stage or the plurality of the pair of sensors;
the sample stage, the source, and the plurality of the pair of pixels are arranged such that the environmental variable represents an interaction between the source and a sample on the sample stage; and
wherein the grid of first areas and the grid of second areas corresponds to areas on the sample stage.

11. The pair of sensors for the microscope of claim 10, wherein adjusting the apparatus includes adjusting one or more of:
an exposure time period;
an orientation of the sample stage;
an intensity of the source; and
a focal point.
